(19) United States
(12) Patent Application Publication
(10) Pub. No.: US 2017/0130867 A1
(43) Pub. Date: May 11, 2017

(54) CUSTOMIZED LINEAR FLOW VALVE FOR OIL FIRED BURNERS

(71) Applicant: Vaijayanti Raju Nagvenkar, Pune (IN)

(72) Inventor: Vaijayanti Raju Nagvenkar, Pune (IN)

(21) Appl. No.: 15/344,929

(22) Filed: Nov. 7, 2016

(30) Foreign Application Priority Data
Nov. 9, 2015 (IN) 4264/MUM/2015

(51) Int. Cl. F16K 37/00; F16K 1/48

(52) U.S. Cl. CPC F16K 37/0016; F16K 1/48

(57) ABSTRACT

A linear flow valve having a fluid inlet, a fluid outlet, a flow path connecting the inlet and outlet, and a stem having an adjustable depth arranged within the flow path for controlling the flow rate through the flow path. The relationship between the depth and flow rate may be a linear relationship. In some embodiments, the linear flow valve may have a second inlet and/or a test point for connecting a gauge to the linear flow valve. The linear flow valve may have a rotatable knob coupled to the stem for adjusting the depth. The depth may be adjustable such that the flow path is completely closed and such that the flow path is completely open. The stem may be threaded and arranged within a threaded bonnet. One or more seals may be arranged between the stem and the bonnet. The stem may have a graduated cross sectional area.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a linear flow valve having a fluid inlet, a fluid outlet, a flow path connecting the inlet and outlet, and a stem having an adjustable depth arranged within the flow path for controlling the flow rate through the flow path. The relationship between the depth and flow rate may be a linear relationship over a complete range of flow ratings. In some embodiments, the linear relationship may be a customizable relationship. The valve may have a second inlet in some embodiments. The valve may have a test point for connecting a gauge to the linear flow valve. In some embodiments, the flow valve may have a rotatable knob coupled to the stem for adjusting the depth. The depth may be adjustable such that the flow path is completely closed and such that the flow path is completely open. In some embodiments, the stem may be arranged within a bonnet, and the stem and bonnet may be threaded. A gauge may provide an indication of depth or stem movement. The stem and flow path may have concentric cross sections. The depth may be controllable manually and/or automatically via an actuator in some embodiments. The flow valve may be integrated in an oil fired burner in some embodiments. The valve may be configured for use with a liquid fluid or gaseous fluid. Moreover, the valve may be configured to be used at any angle of inclination.

The present disclosure, in one or more embodiments, additionally relates to a customized flow valve for controlling a flow rate in an oil fired burner. The flow valve may have a fluid inlet, a fluid outlet, a flow path connecting the inlet and outlet, and an orifice bisecting the flow path. A stem may be arranged within the orifice, the stem having a depth extending into the flow path. In some embodiments, the relationship between the depth and a flow rate through the flow path may be a linear relationship over a complete range of flow ratings. In some embodiments, the depth may be adjustable so as to adjust the flow rate through the flow path. The flow valve may have a rotatable knob coupled to the stem for adjusting the depth. The depth may be adjustable such that the flow path is completely closed and such that the flow path is completely open. In some embodiments, the valve may have a second inlet.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 (consisting of 1A and 1B) is a schematic representation of typical front views of two embodiments of the CUSTOMIZED LINEAR FLOW VALVE FOR OIL FIRED BURNERS.

FIG. 2 (consisting of 2A and 2B) is a schematic representation of side views of two embodiments of the CUSTOMIZED LINEAR FLOW VALVE FOR OIL FIRED BURNERS.

FIG. 3 (consisting of 3A and 3B) is a schematic representation of sectional views of two embodiments of the CUSTOMIZED LINEAR FLOW VALVE FOR OIL FIRED BURNERS.

FIG. 4 (consisting of 4A and 4B) is a schematic representation of top views of two embodiments of the CUSTOMIZED LINEAR FLOW VALVE FOR OIL FIRED BURNERS;

FIG. 5 is a schematic representation of the needle (stem) of the CUSTOMIZED LINEAR FLOW VALVE FOR OIL FIRED BURNERS.

FIG. 6 is a detailed view of the needle of the CUSTOMIZED LINEAR FLOW VALVE FOR OIL FIRED BURNERS along with its related characteristics.

FIG. 7 illustrates characteristic curves of the CUSTOMIZED LINEAR FLOW VALVE FOR OIL FIRED BURNERS, with displacement of the needle plotted on X axis and flow plotted on Y axis. The Figure shows characteristics of various embodiments of the valve, with different (customized) characteristics, each characteristic providing linear output flow.

FIG. 8 shows a displacement versus flow diagram for an inventive valve, according to one or more embodiments.

### DETAILED DESCRIPTION

This invention reveals a flow control valve utilizing a contoured valve stem, which is customized to provide linear curves suitable for controlling burners being fired in a furnace or a combustion system. Considered in this application, are two embodiments of the said valve, viz., embodiment ‘A’ and embodiment ‘B’. The embodiment ‘B’ is an enhancement of the embodiment ‘A’.

The main body, made of any material, ensures high pressure resistance and a leak proof construction. In the first embodiment of this valve, this main body consists of three end connections, one each for fluid inlet, fluid outlet and connecting the pressure gauge (test point). In the second embodiment of this valve, the main body consists of two end connections, one each for fluid inlet and fluid outlet. In this embodiment, separate provision has been made for connecting the pressure gauge (test point). In the two embodiments, the main body also has a connection for fitting an actuator when required to control the valve by electrical or other signals. The main body has a linear scale marked on the periphery, to note the position of the opening (at the orifice) of the valve.

The knob is made from any material, used to regulate flow; and is integrated with the stem. The knob has a circular scale marked on it, to note the position of opening (at the orifice) of the valve.

The bonnet, made from any material, is a leak-proof enclosure for the valve body. It is threaded at the top and bottom portions, in order to hold the main body at one end and the stem at the other. The stem (or needle), made from any material, is a precision internal component, part of which seats with the orifice, in order to control the opening of the orifice. Other part of the stem connects with the threads on the bonnet to provide axial motion.

Seals made from any sealing material have been provided to achieve sealing and leak-proofing at designated pressures.

For accurate control and monitoring, the valve has been provided with circular as well as linear metering scales on the knob and the main body or bonnet respectively.

Referring to the principle of conservation of energy and the Bernoulli equation, it is known that the flow through an orifice is directly proportional to the square root of the differential pressure across the orifice and inversely proportional to the specific gravity of the fluid.

Q=Cv*√(ΔP/G) (1)
Where:
Q is flow rate in m3/hr
Cv is valve coefficient that is determined for every type of valve
ΔP is differential pressure across the inlet and outlet of the valve
G is the specific gravity of the fluid.
   In this invention, the flow of fluid or oil through the valve is determined by the concentric opening between the cross-section of the orifice and the needle cross-section at the orifice.

Q=Cv*A*√(ΔP/G) (2)
Where:
A=cross-sectional area of flow

And A=Ao−An (3)
Where:
Ao is area of orifice (major area)
An is area of needle at the orifice (minor area)
   Working on the above equations, we have,

Q=Cv*(Ao−An)*√(ΔP/G) (4)

Considering that the flow maintains a consistent differential pressure and that the cross-sectional area of the orifice is fixed, equation 4 can be represented as:

Q=K−(K1*An) (5)

As per the equation 5, as the product (K1*An) approaches the value of K, Q=Qmin=0

Above equations 4 and 5 indicate that, as the needle area approaches or equals the orifice area, the flow is nil, signifying that the valve is in closed position. Maximum flow will be achieved when the area of the needle is minimum at the orifice. So also, equation 5 also indicates that when the product (K1*An) is minimum, Q=Qmax This condition is satisfied when the needle area An is minimum at the orifice opening. At this position, the flow through the valve is maximum. Equation 5 indicates that the flow is proportional to the available area at the orifice, i.e., flow is proportional to the difference in areas of the orifice and cross-sectional area of the needle at the orifice. From the above equations, it is evident that flow through the valve varies depending on the area of the needle at the plane of the orifice. Thus, in order to achieve a desired linear flow, the cross-sectional area of the needle is maintained such as to provide a desired characteristic of flow.

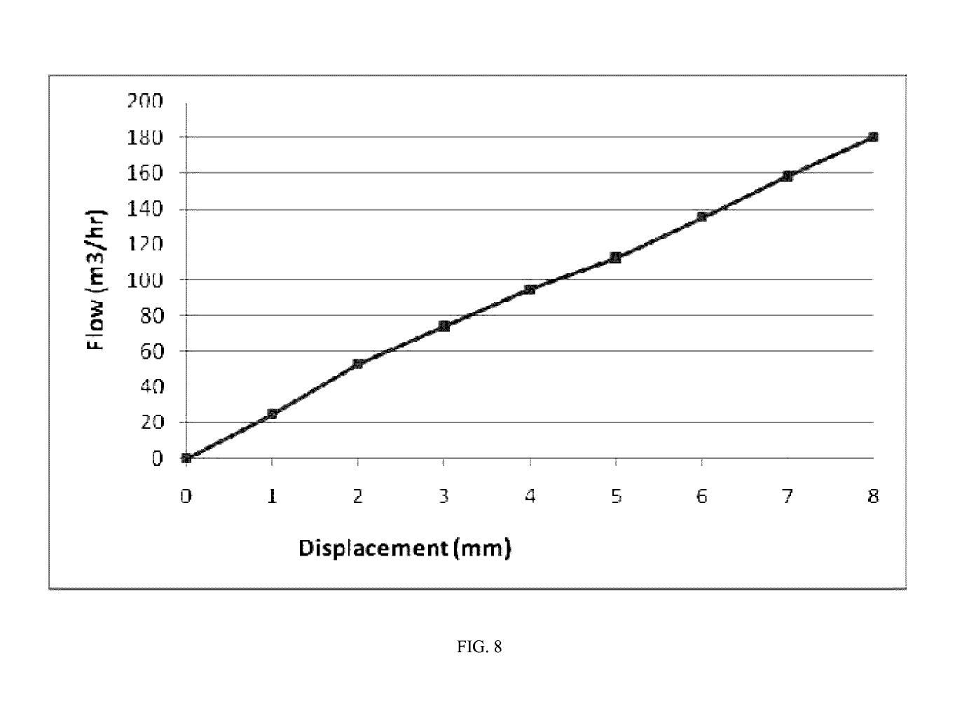

FIG. 8 shows the characteristic of the invented valve, as designed and achieved.

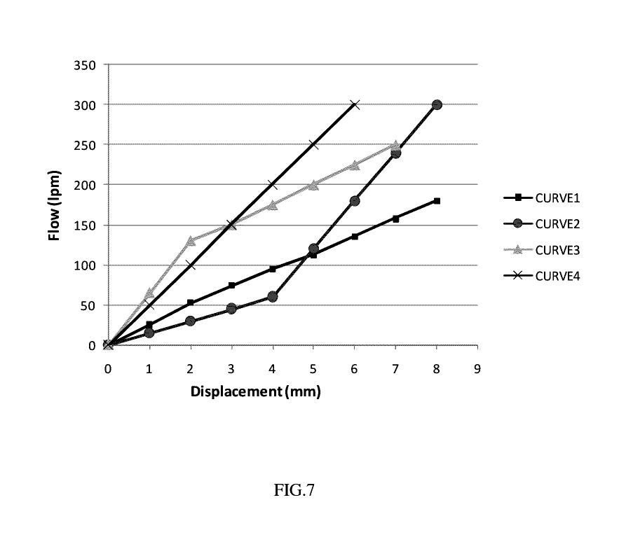

The stem/needle of the invented valve are designed based on the process requirement of the burner, and the application that it is used for. In the characteristic curves shown in FIG. 7, the different curves are to be interpreted as follows:

a) Curve 1: typically used for burners with low capacity, where required rate of fuel flow is low.

b) Curve 2: is for processes that start with slow heating, and later require fast and uniform heating.

c) Curve 3: used for processes that require a fast rate of heating initially and after a certain point, rate of heating reduces.

d) Curve 4: used for high capacity burners, where rate of fluid flow required is consistently high.

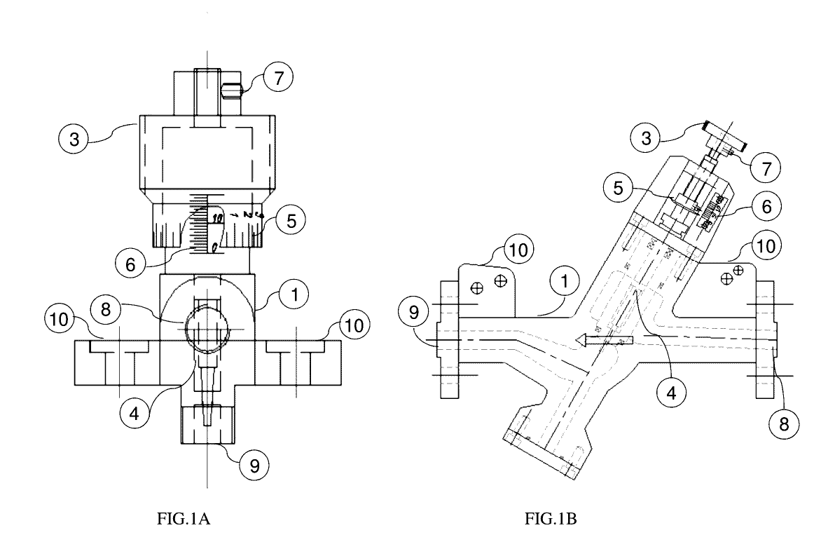

FIGS. 1 (1A and 1B) of the accompanying drawings illustrates a typical front view of the customized linear flow valve, with the main body 1 and knob 3, in accordance with the present invention. The main body houses the inlet ports 8 and the outlet port 9. The connection of this outlet port 9 is also utilized for mounting the valve at the burner body. In the first embodiment of the valve (FIG. 1A), two inlet ports have been provided, to facilitate connecting the inlet port from any direction. The second inlet port can either be plugged, or utilized for connecting a pressure gauge. The second embodiment of the valve (FIG. 1B) has one inlet port. In the first embodiment of the valve (FIG. 1A), the main body 1 has a linear scale 6 marked on it to indicate the opening of the valve, as in, the number of turns that the valve has opened. In the second embodiment of the valve (FIG. 1B), the bonnet 2 has a linear scale 6 marked on it to indicate the opening of the valve. Mounting holes 10 on the main body enable mounting of the external actuator which facilitates automation and control of the valve. The knob 3 sits on the top-most part of the total assembly. The knob has a circular scale 5 marked on it, which indicates the degree of opening in each turn. The needle (stem) 4 is internal to the valve assembly. The upper part of this needle (stem) is connected with the knob using a grub screw 7.

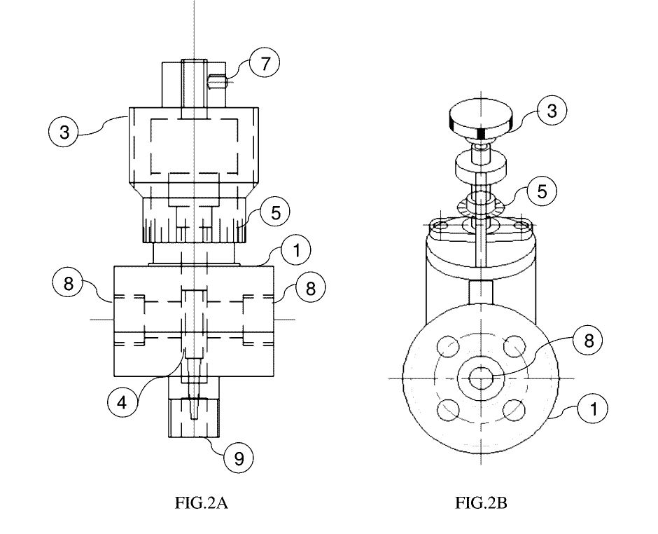

FIG. 2 illustrates a side view of the customized linear flow valve, wherein the two inlet ports are shown distinctly, in the first embodiment (FIG. 2A). In the second embodiment (FIG. 2B), a typical connection method for the inlet port is seen.

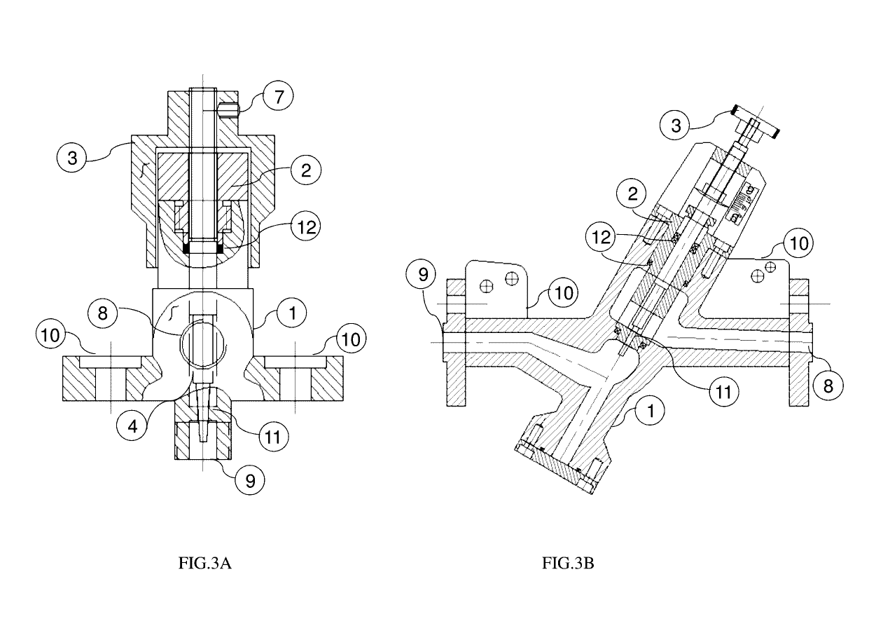

FIGS. 3 (3A and 3B) illustrates a sectional view of the two embodiments of the present invention. The position of the bonnet 2, which links the main body, the needle (stem) and the knob is evident. The seals 12 prevent any chance of leakage from the valve. The needle 4 passes through the annular orifice 11, and determines the amount of fluid that can pass through.

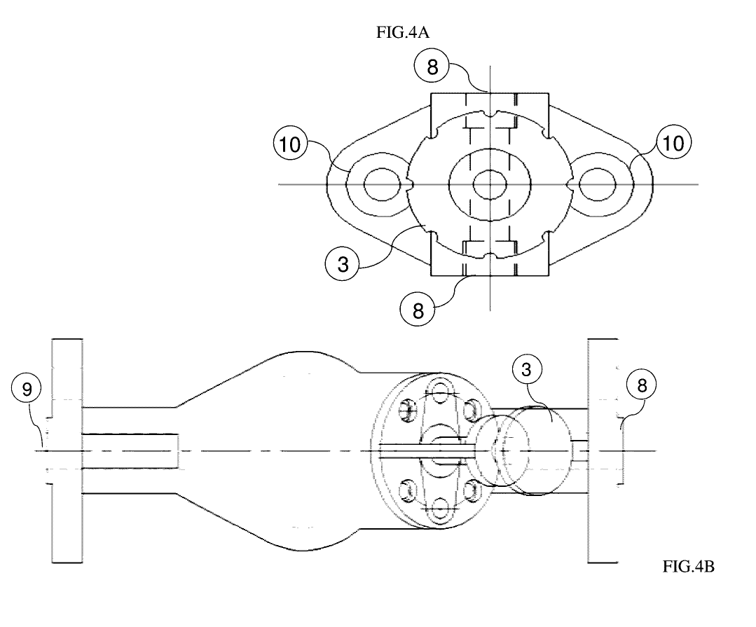

FIGS. 4 (4A and 4B) indicates the top view of the customized linear flow valve, in the two embodiments.

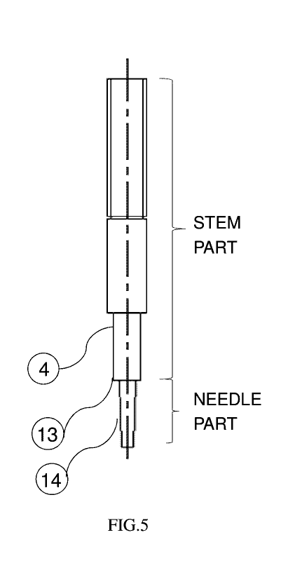

FIG. 5 illustrates the needle/stem 4 of an embodiment of the present invention. The stem part and the needle part are as indicated in the said figure. The seat 13 rests on the annular orifice 11 during the ‘closed’ state of the linear flow control valve. It is the needle part 14 of this component which has a customized cross-sectional area, which is concentric to the orifice housed in the main body 1.

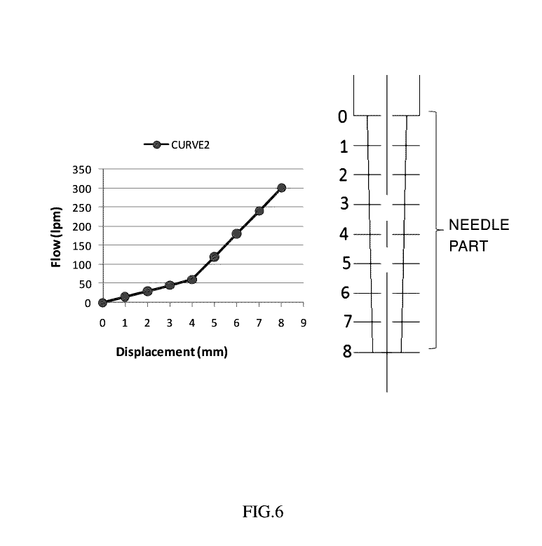

FIG. 6 illustrates the needle 14 of an embodiment of the present invention. It is only the needle part 14 that has been shown in an exploded view. Also shown in the figure is a typical characteristic curve. This figure illustrates a step-wise division of the needle, and the corresponding resultant characteristic curve obtained. The cross-sectional area of the needle is maintained at each step so that the desired output is obtained as indicated in the curve. The distance between the steps indicated in the figure is only illustrative and the actual design considers far more closer (finer) steps.

FIG. 7 illustrates the characteristic curves of the customized linear flow valve, with displacement of the needle plotted on X axis and flow plotted on Y axis. The stem and needle of the invented valve are designed based on the process requirement of the burner, and the application that it is used for. In the characteristic curves shown in the FIG. 7, the different curves are to be interpreted as follows:
a) Curve 1: typically used for burners with low capacity, where required rate of fuel flow is low.
b) Curve 2: is for processes that start with slow heating, and later require fast and uniform heating.
c) Curve 3: used for processes that require a fast rate of heating initially and after a certain point, rate of heating reduces.
d) Curve 4: used for high capacity burners, where rate of fluid flow required is consistently high.

Generally, in Embodiments A and B, movement of the stem/needle can be controlled either manually by turning a knob or automatically, with the help of any type of actuator. The linear relationship between needle depth and flow rate may be over a complete range of flow rating of the valve. Even when the slope of the characteristic changes, the linearity of flow is maintained.

Two embodiments, Embodiment A and Embodiment B, have been described with respect to FIGS. 1-7. Some differences between Embodiment A and Embodiment B are described below.

| Sr. | | |
|---|---|---|
| No. | Embodiment ‘A’ (ref FIG. 1A) | Embodiment ‘B’ (ref FIG. 1B) |
| 1 | The inlet and outlet ports are | The inlet and outlet ports are in- |
| | perpendicular to each other. | line with each other. |
| 2 | Has two inlet ports - one to be | Has one inlet port. |
| | used for inlet of fluid and other | Separate facility provided for |
| | as test point. | test point. |
| | Has one outlet port. | Has one outlet port. |
| 3 | The linear scale provided on the | The linear scale provided on the |
| | main body. | bonnet. |
| 4 | End connections for the inlet and | End connections for the inlet and |
| | outlet ports are threaded. | outlet ports can be threaded or |
| | | flanged or any type. |

Remarks on the differences:
1) The two embodiments have their respective advantages. The first embodiment ‘A’ provides ease of mounting on a burner block. The second embodiment, though can be mounted near a burner block, is more useful when there's a requirement to connect it in a straight pipeline. In the second embodiment ‘B’, as the inlet and outlet ports are in-line, it is easier to connect the valve on a straight pipeline.
2) Providing two inlet ports makes the valve bulky, and hence the second embodiment ‘B’ has been provided with one inlet port; and an additional facility for a test point.
3) For ease of viewing, the second embodiment ‘B’ has the linear scale fixed on the bonnet rather than the main body.
4) The second embodiment ‘B’ provides flexibility with the type of end connections for the inlet and outlet ports.

It is to be appreciated that there is no limitation on the nomenclature of various parts or components mentioned in the descriptions above and mentioned in the claims. Moreover, the parts or components described herein may be constructed of one or more metals, plastics, or any other suitable materials. The valves described herein may be suitable for use with generally any fluid, including any suitable liquid or gas. Additionally, the valves described herein may be generally used in any suitable position, including a vertical, horizontal, or position having any suitable angle of inclination.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A customized linear flow valve comprising:
a fluid inlet;
a fluid outlet;
a flow path connecting the inlet and outlet; and
a stem having an adjustable depth arranged within the flow path for controlling the flow rate through the flow path;
wherein the relationship between the depth and flow rate is a linear relationship over a complete range of flow ratings.

2. The linear flow valve of claim 1, wherein the linear relationship is a customizable relationship.

3. The linear flow valve of claim 1, further comprising a second inlet.

4. The liner flow valve of claim 1, further comprising a test point for connecting a gauge to the linear flow valve.

5. The linear flow valve of claim 1, further comprising a rotatable knob coupled to the stem for adjusting the depth.

6. The linear flow valve of claim 1, wherein the depth is adjustable such that the flow path is completely closed and such that the flow path is completely open.

7. The linear flow valve of claim 1, wherein the stem is arranged within a bonnet.

8. The linear flow valve of claim 7, wherein the stem and bonnet are threaded or sliding.

9. The linear flow valve of claim 1, further comprising a gauge providing an indication of depth or stem movement.

10. The linear flow valve of claim 1, wherein the stem and the flow path have concentric cross sections.

11. The linear flow valve of claim 1, wherein the depth is controllable manually.

12. The linear flow valve of claim 1, wherein the depth is controllable automatically with an actuator.

13. The linear flow valve of claim 1, wherein the linear flow valve is integrated in an oil fired burner.

14. The linear flow valve of claim 1, wherein the valve is configured for use with a liquid fluid or a gaseous fluid.

15. The linear flow valve of claim 1, wherein the valve is configured to be used at any angle of inclination.

16. A customized flow valve for controlling a flow rate in an oil fired burner, the flow valve comprising:
a fluid inlet;
a fluid outlet;
a flow path connecting the inlet and outlet;
an orifice bisecting the flow path; and
a stem arranged within the orifice, the stem having a depth extending into the flow path;
wherein the relationship between the depth and a flow rate through the flow path is a linear relationship over a complete range of flow ratings.

17. The flow valve of claim 16, wherein the depth is adjustable so as to adjust the flow rate through the flow path.

18. The flow valve of claim 17, further comprising a rotatable knob coupled to the stem for adjusting the depth.

19. The flow valve of claim 17, wherein the depth is adjustable such that the flow path is completely closed and such that the flow path is completely open.

20. The flow valve of claim 16, further comprising a second inlet.
